(19) United States
(12) Patent Application Publication
(10) Pub. No.: US 2022/0306444 A1
(43) Pub. Date: Sep. 29, 2022

(54) APPARATUS FOR OPENING AND CLOSING SAMPLE STORAGE CONTAINERS

(71) Applicant: Republic of Korea(National Forensic Service Director Ministry of Interior and Safety), Wonju-si (KR)

(72) Inventors: Min Ho Lee, Wonju-si (KR); Eu-Ree Ahn, Pohang-si (KR); Kyungmyung Lee, Wonju-si (KR); Jong Keun Jung, Wonju-si (KR); Yoonjung Cho, Wonju-si (KR); Dong Sub Lee, Wonju-si (KR); Jin Myung Lee, Wonju-si (KR)

(21) Appl. No.: 17/699,100

(22) Filed: Mar. 19, 2022

(30) Foreign Application Priority Data
Mar. 23, 2021 (KR) 10-2021-0037292

(51) Int. Cl. B67B 7/44; B65B 7/28; B67B 6/00

(52) U.S. Cl. CPC B67B 7/44; B65B 7/2842; B67B 6/00

(57) ABSTRACT

Disclosed is an apparatus for opening and closing sample storage containers, including: a housing 110 having an external appearance provided such that a handle 130 held by a user is exposed; a driving device 180 for generating driving force to rotate a rotation shaft; a key 150 fitted and coupled to a lid 1 of at least one sample storage container and configured to be rotated by the driving force; and an ejector 160 for pressing the lid 1 when the handle 130 is pressed, so that the key 150 is disengaged from the lid 1.

### CROSS-REFERENCE TO RELATED APPLICATION

This application claims priority to and the benefit of Korean Patent Application No. 2021-0037292, filed on Mar. 23, 2021, the disclosure of which is incorporated herein by reference in its entirety.

### BACKGROUND OF THE INVENTION

### 1. Field of the Invention

The present disclosure provides an apparatus for opening and closing sample storage containers, and more particularly the apparatus can automatically open/close lids of containers for storing a drug or a sample to be used in a test.

### 2. Description of the Related Art

Conventionally, a drug or a sample to be used in a test is enclosed in a small cylindrical container called a tube, and these tubes are erected and mounted in a vertical and/or horizontal direction on a rack for storage and transport.

A container for storing a sample is generally composed of a body that forms a space for accommodating a sample therein; and a cap that opens/closes an opening of the container by a screw manner or a press-fit manner to access a receiving space of the body.

However, there is an increasing demand to store a tube in a frozen or refrigerated state rather than in an room-temperature environment, and to maintain a sealed state so as to prevent leakage of a sample accommodated inside a body of a container, and thus, the demand for a screw-type cap is greater than for a cap opened/closed in a press-fit manner.

In the case of a tube (or sample storage container) having such a screw-type cap (or lid), there is a risk of sample contamination when opened/closed by an operator, and when several sample storage containers need to be opened and closed, the containers should be respectively and individually opened and closed, which causes unnecessary consumption of time and labor.

Accordingly, there is an increasing demand for a technology capable of solving these problems.

### RELATED ART DOCUMENTS

### Patent Documents

(Patent Document 1) JP2003-300592 A
(Patent Document 2) JP2005-145540 A
(Patent Document 3) JP2020-033033 A
(Patent Document 4) JP6718058 B1
(Patent Document 5) KR10-1620803 B1
(Patent Document 6) JP2000-203691 A
(Patent Document 7) JP2003-300591 A
(Patent Document 8) JP4578719 B1

### SUMMARY OF THE INVENTION

Therefore, the present disclosure has been made in view of the above problems, and it is an object of the present disclosure to provide an apparatus for opening and closing sample storage containers, the apparatus being capable of simultaneously and automatically opening/closing a plurality of lids of containers for storing a drug or a sample to be used in a test.

In accordance with an aspect of the present disclosure, the above and other objects can be accomplished by the provision of an apparatus for opening and closing sample storage containers, including: a housing 110 having an external appearance provided such that a handle 130 held by a user is exposed; a driving device 180 for generating driving force to rotate a rotation shaft; a key 150 fitted and coupled to a lid 1 of at least one sample storage container and configured to be rotated by the driving force; and an ejector 160 for pressing the lid 1 when the handle 130 is pressed, so that the key 150 is disengaged from the lid 1.

In accordance with an embodiment, the lid 1 may have a lid recess 11 on a top thereof, and a plurality of lid protrusions 12 may be formed to protrude along an inner circumferential surface of the lid recess 11.

In accordance with an embodiment, a lower end of the key 150 may be fitted and coupled to the lid recess 11 and may have a polygonal pole shape, wherein cross sections of the lower end are widened upward.

In accordance with an embodiment, the key 150 may no longer press the lid 1 in a locking direction when a resistance force above a certain value is generated when rotated in the locking direction about a shaft by the driving force.

In accordance with an embodiment, the key 150 may include a key-coupling part 175 to be fitted and coupled to the lid 1; and a shaft 174 for transmitting the driving force to the key-coupling part 175, wherein coupling between an upper end of the key-coupling part 175 and a lower end of the shaft 174 is gear coupling.

In accordance with an embodiment, the key-coupling part 175 may include a key groove 1756 formed on an upper part thereof; and a plurality of ratchet protrusions 1757 formed to protrude in any one circumferential direction along an inner circumferential surface of the key groove 1756, thereby forming engraved cogwheels, and the shaft 174 may include a key protrusion 1742 formed to protrude from a lower part thereof; and a plurality of pole rods 1743 formed to extend in a direction opposite to the circumferential direction along an outer circumferential surface of the key protrusion 1742.

In accordance with an embodiment, an end of each of the pole rods 1743 may be caught in an engagement groove 1758 concavely formed between two adjacent ratchet protrusions 1757, thereby preventing the key-coupling part 175 from running idle when the shaft 174 is rotated in an unlocking direction opposite to the locking direction.

In accordance with an embodiment, the key protrusion 1742 may have a polygonal pole shape, and an outer surface of an extended portion formed to extend from a pillar edge of the key protrusion 1742 to each of the pole rods 1743 may be a curved surface, so that the key 150 presses the lid 1 in the locking direction with a driving force less than the certain value by the pillar edge of the key protrusion 1742 and the outer surface of the extended portion.

In accordance with an embodiment, the apparatus may further include: a plurality of belt pulleys 173 respectively coupled to upper ends of the plural keys 150; and a timing belt configured to connect the plural belt pulleys 173 to each other so that the plural keys 150 are rotated by the driving force.

In accordance with an embodiment, an ejector 160 may have a plate shape including a plurality of through-holes 161, and the plural keys 150 may be inserted into the through-holes 161.

In accordance with an embodiment, the handle 130 may include a first inclined portion 1302 whose lower end is inclined downward toward a front, and the apparatus may further include an ejector body 135 interposed between the handle 130 and the ejector 160, wherein the ejector body 135 includes a second inclined portion 1351 formed on an upper end thereof to face the first inclined portion 1302, thereby moving up and down by forward and backward movement of the handle 130 along an inclined portion of the first inclined portion 1302.

In accordance with an embodiment, the apparatus may further include: a portable battery 140 for supplying power to the driving device 180; and a switch 120 for generating a driving input and rotation direction input regarding the driving device 180.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1A and 1B illustrates the overall appearance of an apparatus for opening and closing sample storage containers according to an embodiment of the present disclosure;

FIG. 2 illustrates an internal configuration of an apparatus for opening and closing sample storage containers according to an embodiment of the present disclosure;

FIG. 3 illustrates a state in which a plurality of keys according to an embodiment of the present disclosure are arranged and coupled to each other;

FIG. 4 illustrates the top of a lid of a sample storage container according to an embodiment of the present disclosure;

FIGS. 5A, 5B and 6 illustrate respective parts of a key according to an embodiment of the present disclosure;

FIGS. 7A and 7B illustrate a coupling part between a key-coupling part and shaft according to an embodiment of the present disclosure; and

FIG. 8 illustrates an operation method of an ejector according to an embodiment of the present disclosure.

### DETAILED DESCRIPTION OF THE INVENTION

Hereinafter, the present disclosure will be described in detail by explaining exemplary embodiments of the disclosure with reference to the attached drawings. The same reference numerals in the drawings denote like elements, and a repeated explanation thereof will not be given. In addition, the suffixes “module” and “unit” of elements herein are used for convenience of description and thus can be used interchangeably and do not have any distinguishable meanings or functions. In the following description of the present disclosure, a detailed description of known functions and configurations incorporated herein will be omitted when it may make the subject matter of the present disclosure unclear. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms first, second, third etc. may be used herein to describe various elements, these elements should not be limited by these terms.

These terms are only used to distinguish one element from another element.

It will be understood that when an element is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

The expression of singularity in the present specification includes the expression of plurality unless clearly specified otherwise in the context.

Also, the terms such as “include” or “comprise” may be construed to denote a certain characteristic, number, step, operation, component, or a combination thereof in the specification, but may not be construed to exclude the presence of or a possibility of addition of one or more other characteristics, numbers, steps, operations, components, or combinations thereof.

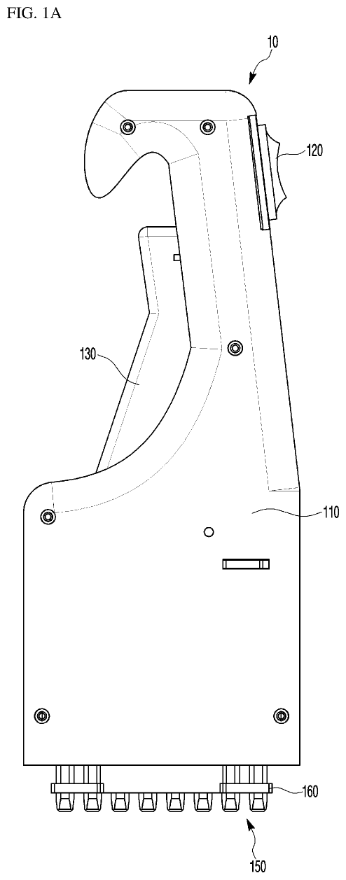

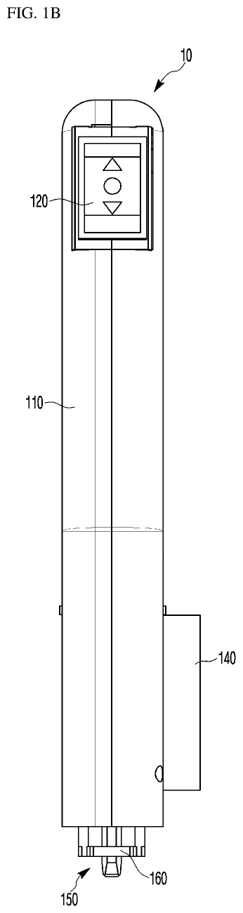

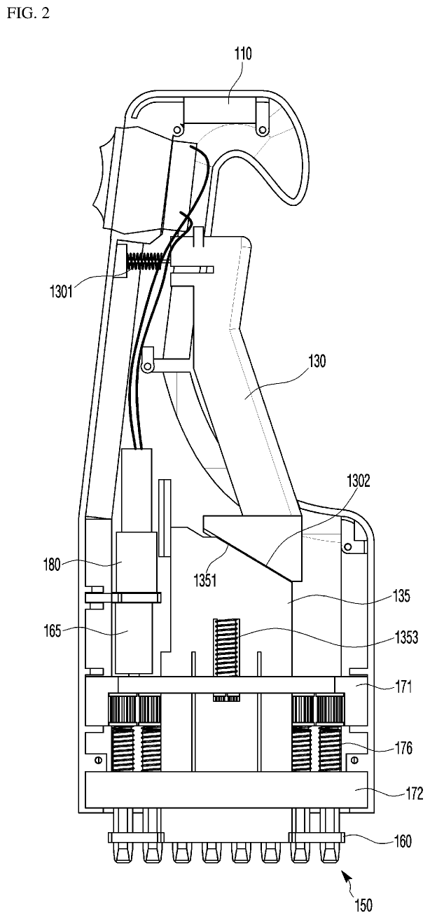

The present disclosure relates to an apparatus capable of automatically opening/closing lids of sample storage containers for storing a drug or a sample to be used in a test. FIGS. 1A and 1B illustrates the overall appearance of an apparatus for opening and closing sample storage containers according to an embodiment of the present disclosure, and FIG. 2 illustrates an internal configuration of an apparatus for opening and closing sample storage containers according to an embodiment of the present disclosure.

As shown in FIGS. 1A and 1B and 2, the apparatus (hereinafter referred to as “opening/closing device”) for opening and closing sample storage containers according to an embodiment of the present disclosure may include a housing 110 having an external appearance provided such that a handle 130 held by a user is exposed; a driving device 180 for generating driving force to rotate a rotation shaft; a key 150 fitted and coupled to a lid 1 of at least one sample storage container and configured to be rotated by the driving force; and an ejector 160 for pressing the lid 1 when the handle 130 is pressed, so that the key 150 is disengaged from the lid 1.

Accordingly, a user may manipulate the switch 120 while holding the opening/closing device according to the present disclosure with one hand, so that the key 150 fitted to the sample storage container lid 1 rotates in any one direction, and thus, the sample storage container lid 1 is opened. Alternatively, the key 150 rotates in an opposite direction by operating the switch 120 in a different manner, thereby closing the sample storage container lid 1.

Here, the opening/closing device according to the present disclosure may include a plurality of keys 150, and thus, may open or close two or more container lids 1 at the same time.

However, the components shown in FIGS. 1A, 1B and 2 are not essential, and it is natural that the apparatus may be implemented as an apparatus having more components or fewer components.

Hereinafter, the components are respectively described in detail.

The housing 110 forms an external appearance of the opening/closing device according to the present disclosure, and the respective components may be provided inside the housing 110.

The external appearance of the housing 110 is not specifically limited, but the housing 110 preferably has a thickness that can be gripped by a user with one hand as shown in FIG. 1B. Here, FIG. 1B illustrates the rear surface of the opening/closing device according to an embodiment of the present disclosure.

In addition, the housing 110 is preferably formed to be inwardly and concavely drawn from at least one side part of the housing 110 such that a user can grip the concave groove portion, as shown in FIG. 1A. Here, FIG. 1A illustrates one side surface of the opening/closing device according to an embodiment of the present disclosure.

Accordingly, a user may grip the opening/closing device with one hand using the concave groove portion of the housing 110. In this state, the switch 120 may be located on an upper part of the rear surface of the housing 110 to easily operate the opening/closing device.

Preferably, there is only one switch 120, and the one switch 120 generates a driving input regarding whether to drive the driving device 180 to be described below or, at the same time, generates a rotational direction input, i.e., a forward or reverse direction input, of a rotation shaft rotated by the driving device 180.

In an embodiment, the rotation shaft of the driving device 180 may rotate in any one direction (e.g., the locking direction of the lid 1) when an upper part of the switch 120 is pressed as shown in FIG. 1B or, conversely, the rotation shaft of the driving device 180 may rotate in an opposite direction (e.g., the unlocking direction of the lid 1) when a lower part of the switch 120 is pressed. When the switch 120 is not pressed, the driving device 180 may not operate.

Meanwhile, the opening/closing device according to an embodiment of the present disclosure may include a power supply for supplying power to the driving device 180 so that the driving device 180 can be driven.

The type of the power supply is not specifically limited so long as it can supply power so that the driving device 180 can generate driving force, but according to a preferred embodiment, the power supply may be a portable battery 140.

Here, the battery 140 may be located inside or outside the housing 110 to be replaceable, but, since the housing 110 should be miniaturized so that a user can grip it with one hand, the battery 140 is preferably provided on the outside of the housing 110 as shown in FIG. 1B.

Meanwhile, the driving device 180 is a device that generates driving force to rotate the rotation shaft directly or indirectly connected thereto, and is not specifically limited so long as it can rotate the rotating shaft. For example, the driving device 180 may be a motor.

As shown in FIG. 2, the driving device 180 may be provided inside the housing 110 and thus may rotate the downwardly disposed rotation shaft.

The key 150 may be coupled with the rotation shaft so that the rotation shaft rotates the key 150 in a locking or unlocking direction according to driving of the driving device 180.

Here, a coupler 165 may be provided on the rotation shaft (or drive shaft) of the driving device 180 according to an embodiment of the present disclosure. The coupler 165 may transmit the driving force of the driving device 180 to the key 150.

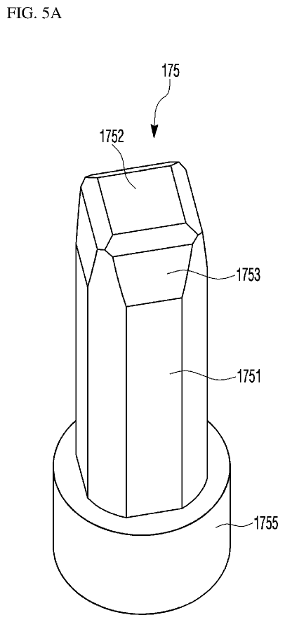

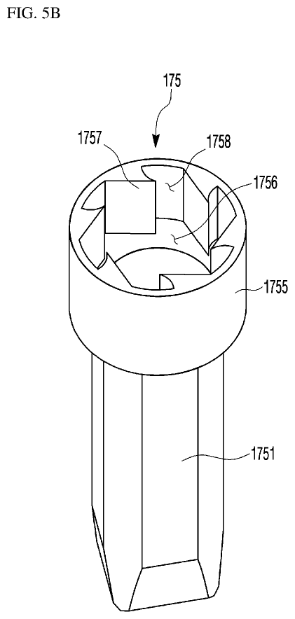

FIGS. 5A and 5B illustrates a lower end of the key 150 according to an embodiment of the present disclosure.

As shown in FIGS. 5A and 5B, a lower end of the key 150 may have a substantially polygonal pole shape.

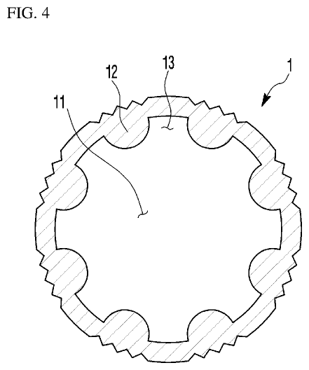

That is, the shape of the lower end of the key 150 according to an embodiment of the present disclosure is not specifically limited so long as it is a polygonal pole shape that can be fitted and coupled to a lid recess 11 formed on the top of the lid 1 shown in FIG. 4. For example, the shape may be a quadrangular pole shape.

The lid recess 11 may be concavely formed in the central portion of the top of the lid 1 such that the key 150 is fitted and coupled to the top of the lid 1, and a plurality of lid protrusions 12 may be formed to protrude toward the lid recess 11 along the inner circumferential surface of the lid recess 11 so that the key 150 may be interposed between the plural lid protrusions 12 by pressing the outer periphery of the key 150 inserted in the lid recess 11.

Here, the shape or number of the lid protrusions 12 protruding from the inner circumferential surface of the lid recess 11 is not specifically limited. Preferably, the lid protrusions 12 are formed such that the pillar edge of the key 150 is caught in a lid-engaging groove 13 formed between the lid protrusions 12 adjacent to each other.

Accordingly, the key 150 is fitted and coupled to the inner circumferential surface, from which the plural lid protrusions 12 protrude, of the lid recess 11, so that the lid 1 is rotated is rotated by at least one of the lid protrusions 12, as an action point, as the key 150 rotates. The sample storage container may be opened/closed by rotating the lid 1 in a locking or unlocking direction of the sample storage container along the rotation direction of the key 150.

Here, cross sections of the polygonal pole at the lower end of the key 150 according to an embodiment of the present disclosure are gradually widened upward.

In an embodiment, when the lower end of the key 150 has a square column shape as shown in FIGS. 5A and 5B, each bottom corner of the square column may have an inclined surface 1753 formed to be inclined outward toward an upper side.

Due to the inclined surfaces 1753 formed on the lower end of the key 150, the key 150 may be more deeply fitted into the lid recess 11 when the key 150 is inserted into the lid recess 11 to be fitted thereto, so that the bonding force between the key 150 and the lid 1 further increases.

Meanwhile, the opening/closing device according to an embodiment of the present disclosure may include an ejector 160 for disengaging the key 150 from the lid 1.

The ejector 160 has a substantially plate shape and may include a plurality of through-holes 161 perforated along the longitudinal direction thereof. The key 150 having a substantially rod shape may be fitted into each of the plural through-holes 161 such that the key 150 can be raised and lowered in a vertical direction in a state of being inserted into each of the plural through-holes 161.

Preferably, the inner diameter of the through-holes 161 is equal to or greater than the outer diameter of the key 150 and is smaller than the outer diameter of the lid 1. Preferably, the through-holes 161 are perforated such that the key 150 passes through the through-holes 161, but the lid 1 cannot pass through the through-holes 161.

In addition, the operation of the ejector 160 may be linked with the operation of the handle 130.

That is, when the handle 130 provided in the concave groove portion of the housing 110 to be gripped with the user's hand is pressed inward from one side of the housing 110 by the grip of the user's hand, the ejector 160 may move in a downward direction.

The housing 110 may be provided with only one handle 130 and, without being limited thereto, may be provided with a pair of handles. The pair of handles may be respectively provided at front and rear of the housing 110. When a user simultaneously grabs the handles provided at the front and rear sides, the ejector 160 may move downward.

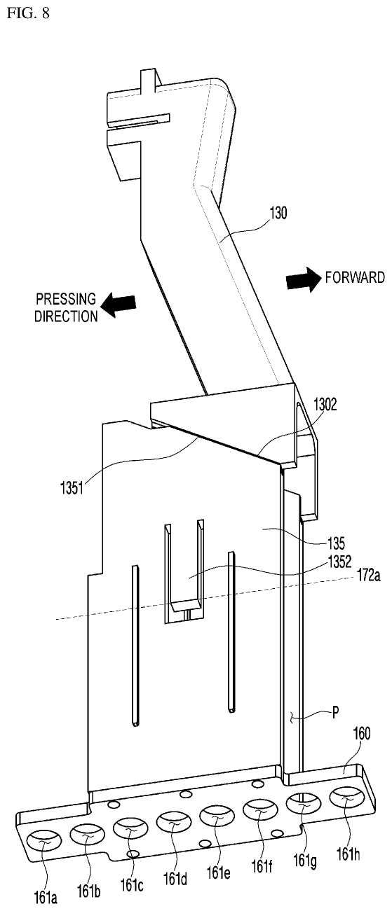

FIG. 8 illustrates an operation method of an ejector according to an embodiment of the present disclosure.

As shown in FIG. 8, a lower end of the handle 130 and an upper end of an ejector body 135 may be in contact with each other to face each other, and a lower end of the ejector body 135 may be provided with an ejector 160 having at least one through-hole 161 into which at least one downwardly-disposed key 150 is to be inserted. The lower end of the handle 130 and the upper end of the ejector body 135 are in contact with each other to face each other, and the contacting portion is preferably inclined downward toward the front.

Specifically, the lower end of the handle 130 may have a first inclined portion 1302 that is inclined downward toward the front, and the first inclined portion 1302 may be in contact with a second inclined portion 1351. The upper end of the ejector body 135 may have the second inclined portion 1351 that is inclined downward toward the front, and the second inclined portion 1351 may be in contact with the first inclined portion 1302 as described above.

Accordingly, when the handle 130 is drawn into the housing 110 in a pressed direction, the upper end of the ejector body 135 may move along the first inclined portion 1302 to be in contact with the upper end, so that the ejector body 135 may move downward.

When the handle 130 is moved in a pressed direction by external force in a state in which the key 150 is fitted into the lid recess 11 of the lid 1, the ejector body 135 and the ejector 160 coupled to a lower side of the ejector body 135 move downward to push the lid 1, so that the key 150 is separated from the container lids 1.

Meanwhile, at least one elastic means 1301 may be provided at the rear of the handle 130. Here, an end on another side of the elastic means 1301 may be fixed to be in contact with an inner wall of the housing 110 (see FIG. 2).

When the handle 130 is drawn into the housing 110 in a pressed direction by external force, and the ejector 160 is moved downward, and then the external force is removed from the handle 130, the handle 130 may be returned to the front position by the elastic restoring force of the elastic means 1301.

Accordingly, an elastic means-coupled protrusion 1352 may be provided on one side or both sides of the ejector body 135 such that the ejector 160 coupled to a lower side of the ejector body 135 is moved upward and returned in conjunction with the handle 130, and the elastic means 1353 may be fitted and coupled to the elastic means-coupled protrusion 1352.

A lower end of the elastic means 1353 coupled to the elastic means-coupled protrusion 1352 may be fixed to and supported by an upper surface 171a of a timing belt box 171 (or an operation part 170) according to an embodiment of the present disclosure described below. That is, by fixing to the timing belt box 171 (or the operation part 170) by whose lower end does not move up and down, the ejector body 135 may move up and down following the movement of the returning handle 130 by the elastic restoring force of the elastic means 1353 when external force applied to the ejector 160 is removed.

Reference numeral p of FIG. 8 denotes an accommodating space, in which the key 150 is accommodated, inside the ejector body 135, and the ejector body 135 may be moved up and down by external force and elastic restoring force regardless of the operation of the key 150.

Meanwhile, the opening/closing device according to an embodiment of the present disclosure may include one or more keys 150. When a plurality of keys 150 are included, the number of the keys 150 may be for example six, but it is not specifically limited.

Here, the plural keys 150 are preferably interlocked with each other when rotating in a locking or unlocking direction.

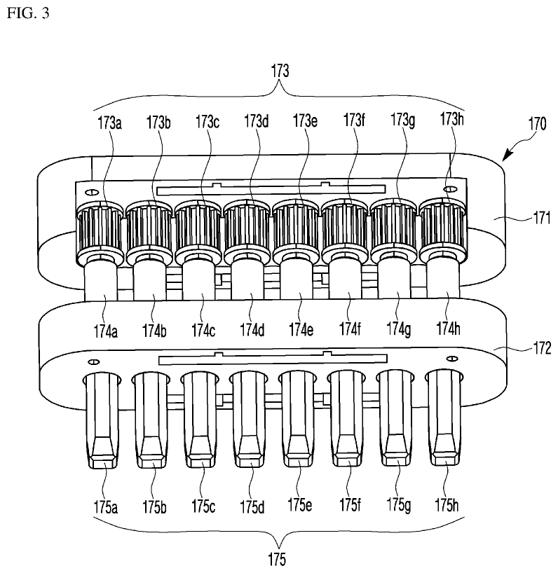

FIG. 3 illustrates a state in which the plural keys according to an embodiment of the present disclosure are arranged and coupled to each other.

As shown in FIG. 3, the plural keys 150 according to an embodiment of the present disclosure are inserted into and fixed to the key holder 172. Here, the plural keys 150 inserted into the key holder 172 are preferably coupled to the key holder 172 so as to be each independently rotated.

An upper end of each of the plural keys 150 may be coupled with each belt pulley 173 such that the plural keys 150 interwork with each other, and the outer circumferential surface of the plural belt pulleys 173 is engaged and coupled with a single timing belt (not shown) so that the plural belt pulleys 173 rotate in conjunction with each other via the single timing belt.

Here, the timing belt and belt pulley 173 according to a preferred embodiment may be accommodated inside the timing belt box 171 that has a fixed position inside the housing 110. In addition, the elastic means 1353 having one supported end may be provided on an upper surface of the timing belt box 171 as described above, so that the ejector body 135 is moved up and down toward the handle 130 by elastic restoring force.

When any one of the keys 150 according to an embodiment of the present disclosure is rotated in a locking or unlocking direction by driving force generated by the driving device 180, the remaining keys 150 are interworked via the timing belt, thus being rotated by the same depth in the same direction. Accordingly, the closing/opening apparatus according to an embodiment of the present disclosure may open or close the plural sample storage container lids 1 at the same time with a single operation.

However, since the plural sample storage containers lids 1 are not rotated and closed/opened by the same number of revolutions when the lids 1 are simultaneously opened or closed, it is preferable to continue a closing operation for remaining container lids although some of the container lids 1 are completely closed when the plural container lids 1 are simultaneously closed.

Accordingly, the key 150 according to an embodiment of the present disclosure may no longer press the lids 1 in the locking direction when a resistance force above a certain value is generated when rotated in a locking direction about the shaft by the driving force of the driving device 180. For this, the key 150 according to an embodiment of the present disclosure may include key-coupling parts 175 to be respectively fitted and coupled to the lids 1; and shafts 174 coupled to the key-coupling parts 175 to transmit the driving force of the driving device 180 to the key-coupling parts 175.

Here, each of the shafts 174 and each of the key-coupling parts 175 may have rod-shaped bodies 1741 and 1751. A key protrusion 1742 may protrude from one end of the body 1741 of the shaft 174, and one end of a body 1751 of the key-coupling part 175 may include a coupling part 1755 having a key groove 1756 therein.

In addition, an elastic means 176 may be fitted to the shaft 174 (or the shaft body 1741), as shown in FIG. 2.

Here, a lower end of the elastic means 176 may be supported by a top surface of the key holder 172, and an upper end of the elastic means 176 may be supported by a bottom surface of the belt pulley 173.

Accordingly, the key 150 is not separated to a lower outside of the opening/closing device through the through-holes 161 of the ejector 160 by the elastic restoring force of the elastic means 176 and the belt pulley 173 may maintain the position thereof inside the timing belt box 171.

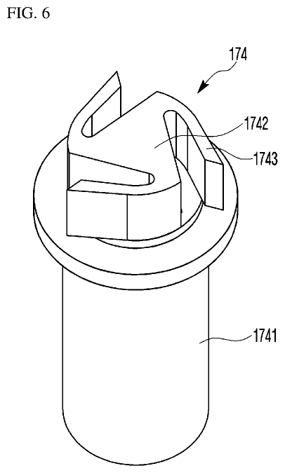

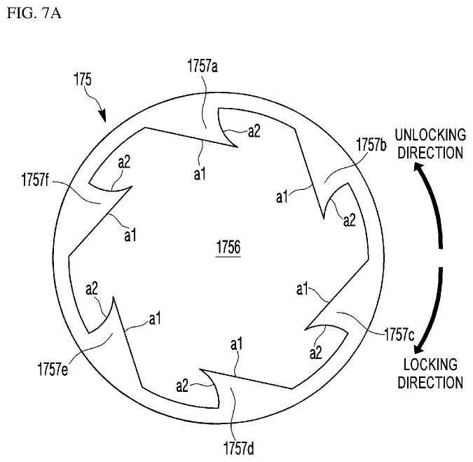

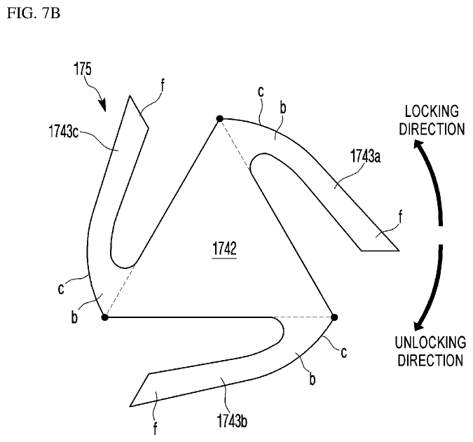

Meanwhile, FIGS. 5A, 5B and 6 illustrate respective parts of a key according to an embodiment of the present disclosure, and FIGS. 7A and 7B illustrate a coupling part between a key-coupling part and shaft according to an embodiment of the present disclosure.

As shown in FIGS. 5A to 7B, the coupling between the upper end of the key-coupling part 175 and the lower end of the shafts 174 is gear coupling, thereby preventing the key 150 from running idle when a resistance force above a certain value is generated upon rotation of the key 150 in an unlocking direction and preventing the key 150 from running idle when a resistance force above a certain value is generated upon rotation of the key 150 in a locking direction.

Specifically, the key-coupling part 175 may have the key groove 1756 that is concavely formed at the top thereof, the key groove 1756 may have a plurality of ratchet protrusions 1757 protruded along the inner circumferential surface thereof, and an end of each of the plural ratchet protrusions 1757 may be formed to protrude in any one circumferential direction (e.g., a locking direction), as shown in the accompanying drawings. Accordingly, engraved cogwheels may be formed on the top of the key-coupling parts 175.

In addition, the shaft 174 may include the key protrusion 1742 that is formed to protrude from the bottom thereof and that is formed to be fitted into the key groove 1756; and a plurality of pole rods 1743 formed to extend in a direction (e.g., an unlocking direction) opposite to the circumferential direction of the key protrusion 1742 along the outer circumferential surface of the key protrusion 1742.

Accordingly, when the key protrusion 1742 is coupled to the key groove 1756 to be engaged therewith, an end f of each of the pole rods 1743 is fitted into an engagement groove 1758 that are concavely formed between the two adjacent ratchet protrusions 1757. Accordingly, when the shafts 174 rotates in the unlocking direction, the end f of each of the pole rods 1743 is caught in the engagement groove 1758, thereby preventing the key-coupling parts 175 from running idle.

Simultaneously, when the key protrusion 1742 having a polygonal pole shape (e.g., a triangular pole shape) are inserted into the key groove 1756 to be engaged therewith, the pillar edge of the key protrusion 1742; and an extended portion b formed to extend from the pillar edge to the pole rod 1743 are caught in the ratchet protrusion 1757, so that the pillar edge of the key protrusion 1742 and/or the extended portion b of the pole rods 1743 press the ratchet protrusion 1757 when the shaft 174 rotates in the locking direction, resulting in rotation of the key-coupling parts 175 in the locking direction.

More preferably, an outer surface c of the extended portion b formed to extend from the pillar edge of the key protrusion 1742 to the pole rods 1743 may have a curved surface, and a first protruding surface a1 of the ratchet protrusions 1757 facing the outer surface c may be formed to be inclined in the locking direction as described above. Accordingly, a force greater than or equal to the resistive force that is set by the curvature of the curved surface c and the inclined angle of the first protruding surface a1 acts between the curved surface c and the first protruding surface a1, the key protrusion 1742 inserted into the key groove 1756 may be idle.

Accordingly, when the sample storage container is completely locked by rotating the lid 1 by a predetermined number of times in the locking direction, the key protrusions 1742 idle even if the key protrusions 1742 inserted in the key grooves 1756 are rotated with force greater than the set resistive force, and thus, the sample storage container is no longer locked with the lid 1. Accordingly, when the opening/closing device according to an embodiment of the present disclosure includes the plural keys 150 and the plural container lids 1 are simultaneously closed with the plural keys 150, the key protrusions 1742 inserted into the key grooves 1756 idle and thus the lids 1 are no longer locked in the case of some container lids 1 completely locked with the lids 1, whereas the remaining container lids 1 are continuously locked.

Meanwhile, unexplained reference numeral a2 denotes a second protruding surface formed on an opposite side of the first protruding surface a1 of the ratchet protrusion 1757. Preferably, the second protruding surfaces a2 are concavely dented curved surfaces.

This is because the ends f of the pole rods 1743 may be easily caught in the engagement grooves 1758 when the key protrusion 1742 is rotated in the unlocking direction by the concave second protruding surfaces a2.

As apparent from the above description, an apparatus for opening and closing sample storage containers according to the present disclosure can simultaneously and automatically open/close a plurality of lids of containers for storing a drug or a sample to be used in a test.

In addition, even if some of the lids are completely closed when the plural lids are closed at the same time, the remaining lids can be continuously closed.

Further, with regard to a key that is fitted to container lids and opens/closes the lids, the key can be easily separated from the container lids by using an ejector for pushing container lids.

Although embodiments of the present disclosure have been described with reference to the accompanying drawings, those skilled in the art will understand that the present disclosure can be easily changed or modified into other specified forms without change or modification of the technical spirit or essential characteristics of the present disclosure.

It should be understood that the scope of the present disclosure is defined by the following claims, rather than the above detailed description and the disclosure is to cover all modifications, equivalents, and alternatives falling within the spirit and scope of the disclosure as defined by the claims.

[Description of Symbols]

| | |
|---|---|
| 1: | lid |
| 11: | lid recess |
| 12: | lid protrusion |
| 110: | housing |
| 120: | switch |
| 130: | handle |
| 1302: | first inclined portion |
| 135: | ejector body |
| 1351: | second inclined portion |
| 140: | battery |
| 150: | key |
| 160: | ejector |
| 161: | through-hole |
| 170: | operation part |
| 171: | a timing belt box |
| 172: | key holder |
| 173: | belt pulley |
| 174: | shaft |
| 1741: | body |
| 1742: | key protrusion |
| 1743: | pole rod |
| 175: | key-coupling part |
| 1751: | body |
| 1755: | coupling part |
| 1756: | key groove |
| 1757: | ratchet protrusion |
| 1758: | engagement groove |
| 180: | driving device |

What is claimed is:

1. An apparatus for opening and closing sample storage containers, comprising:
a housing having an external appearance provided such that a handle held by a user is exposed;
a driving device for generating driving force to rotate a rotation shaft;
a key fitted and coupled to a lid of at least one sample storage container and configured to be rotated by the driving force; and
an ejector for pressing the lid when the handle is pressed, so that the key is disengaged from the lid.

2. The apparatus according to claim 1, wherein the lid has a lid recess on a top thereof, and a plurality of lid protrusions are formed to protrude along an inner circumferential surface of the lid recess.

3. The apparatus according to claim 2, wherein a lower end of the key is fitted and coupled to the lid recess and has a polygonal pole shape, wherein cross sections of the lower end are widened upward.

4. The apparatus according to claim 2, wherein the key no longer presses the lid in a locking direction when a resistance force above a certain value is generated when rotated in the locking direction about a shaft by the driving force.

5. The apparatus according to claim 4, wherein the key comprises a key-coupling part to be fitted and coupled to the lid; and a shaft for transmitting the driving force to the key-coupling part,
wherein coupling between an upper end of the key-coupling part and a lower end of the shaft is gear coupling.

6. The apparatus according to claim 5, wherein the key-coupling part comprises a key groove formed on an upper part thereof; and a plurality of ratchet protrusions formed to protrude in any one circumferential direction along an inner circumferential surface of the key groove, thereby forming engraved cogwheels, and
the shaft comprises a key protrusion formed to protrude from a lower part thereof; and a plurality of pole rods formed to extend in a direction opposite to the circumferential direction along an outer circumferential surface of the key protrusion.

7. The apparatus according to claim 6, wherein an end of each of the pole rods is caught in an engagement groove concavely formed between two adjacent ratchet protrusions, thereby preventing the key-coupling part from running idle when the shaft is rotated in an unlocking direction opposite to the locking direction.

8. The apparatus according to claim 6, wherein the key protrusion has a polygonal pole shape, and an outer surface of an extended portion formed to extend from a pillar edge of the key protrusion to each of the pole rods is a curved surface, so that the key presses the lid in the locking direction with a driving force less than the certain value by the pillar edge of the key protrusion and the outer surface of the extended portion.

9. The apparatus according to claim 1, further comprising: a plurality of belt pulleys respectively coupled to upper ends of the plural keys; and
a timing belt configured to connect the plural belt pulleys to each other so that the plural keys are rotated by the driving force.

10. The apparatus according to claim 1, wherein an ejector has a plate shape including a plurality of through-holes, and
the plural keys are inserted into the through-holes.

11. The apparatus according to claim 10, wherein the handle comprises a first inclined portion whose lower end is inclined downward toward a front, and
the apparatus further comprises an ejector body interposed between the handle and the ejector, wherein the ejector body comprises a second inclined portion formed on an upper end thereof to face the first inclined portion, thereby moving up and down by forward and backward movement of the handle along an inclined portion of the first inclined portion.

12. The apparatus according to claim 1, further comprising:
a portable battery for supplying power to the driving device; and
a switch for generating a driving input and rotation direction input regarding the driving device.
